(19) United States
(12) Patent Application Publication
(10) Pub. No.: US 2013/0305536 A1
(43) Pub. Date: Nov. 21, 2013

(54) Wire Basket Attachment Spade and Spring Wire Trap

(71) Applicant: UNARCO INDUSTRIES, LLC, Wagoner, OK (US)

(72) Inventors: Woody Smith, STILLWATER, OK (US); WESLEY McMURTREY, WAGONER, OK (US)

(73) Assignee: UNARCO INDUSTRIES, LLC, Wagoner, OK (US)

(21) Appl. No.: 13/856,580

(22) Filed: Apr. 4, 2013

Related U.S. Application Data
(60) Provisional application No. 61/648,973, filed on May 18, 2012.

(51) Int. Cl. F16B 2/24

(52) U.S. Cl. CPC F16B 2/248
USPC 29/897.2; 403/329

(57) ABSTRACT

A length of a substantially linear wire is attached to a substantially linear portion of a wire basket rim wire at two spaced-apart locations. The spaced-apart connections allow the two wires to deflect or act as springs when a notched basket-to-frame attachment clip is driven into a hole or loop formed by a detent in one of the wires. A wire basket having the linear spring wire attached to a rim wire can be permanently attached to a frame portion without tools or welding.

### BACKGROUND

Shopping carts, which are comprised of a wheeled frame to which a wire-mesh basket is affixed, are relatively light but nevertheless bulky. While they are designed to be telescoped together, i.e., placing the front end of the basket into a movable rear panel, wire-mesh shopping carts are relatively difficult to economically package and ship in their assembled state. A method and apparatus for facilitating the shipment of frame and basket portions in a disassembled state and which allows the separate portions to be assembled at their point of use, would be an improvement over the prior art.

### BRIEF DESCRIPTION OF THE FIGURES

FIG. 1 is a perspective view of a shopping cart assembly;

FIG. 2 is an isolated perspective view of the shopping cart assembly;

FIG. 3 is an isolated view of the spring wire attached to a rim wire by two welds;

FIG. 4 is a top view of the spring wire lying in a horizontal plane and showing how the spring wire, with an included loop or detent, is oriented when it is attached to a rim wire;

FIG. 5A and FIGS. 5B and 5C are top views of a spring wire having a rim wire attached below the spring wire and showing the action of the two wires relative to each other as they are driven onto a wire spade connector;

FIG. 6 is a depiction of the frame portion showing the spade connector formed on the opposing ends of a relatively stiff heavy gauge generally U-shaped wire connecting rod;

FIG. 7 shows a basket portion attached to a frame portion using the aforementioned two-wire trap;

FIG. 8 is a perspective view of the spade connector; and

FIG. 9 is a typical stress-strain curve.

### DETAILED DESCRIPTION

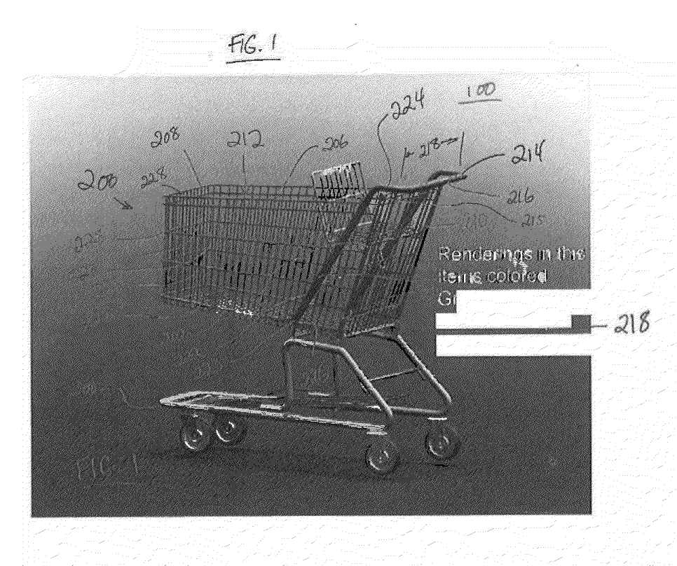

FIG. 1 is a perspective view of a shopping cart assembly 100. The shopping cart assembly 100 is comprised of a wire basket portion 200 and a frame portion 300. The basket portion 200, which is also referred to herein simply as “the basket” has a wire-mesh bottom 202 and two opposing wire-mesh sides or sidewalls 204 and 206. A wire-mesh front end 208 and a wire-mesh inclined back end 210 define a wire-mesh basket with an open top 212. The wire-mesh inclined back end 210 is able to flip up, i.e., rotate inwardly, around a hinge-like connection 215 located in front of the horizontal handle portion 214. Relatively heavy-gauge wires denominated herein as “rim” wires 228 are stiff and provide strength to the sidewalls 204 and 206 and the bottom 202.

The basket portion handle 214 is comprised of an elongated length of relatively large-diameter tubing or tube 216 bent or otherwise formed to provide a horizontal user portion 214 having a width 218 that is slightly larger than the overall width 220 of the inclined back end 210. Two sloping or inclined handle extensions 222 extend downwardly from two, horizontal and forwardly-extending handle portions 224 to where the angled handle extensions 222 meet and are attached to a rim wire-reinforcing spring wire 226. The inclined portions 222 are shown as being inclined at an angle θ (theta) relative to the bottom 202. The inclined handle portions 222 have bottom ends 223 that are attached to substantially horizontal spring wires 226.

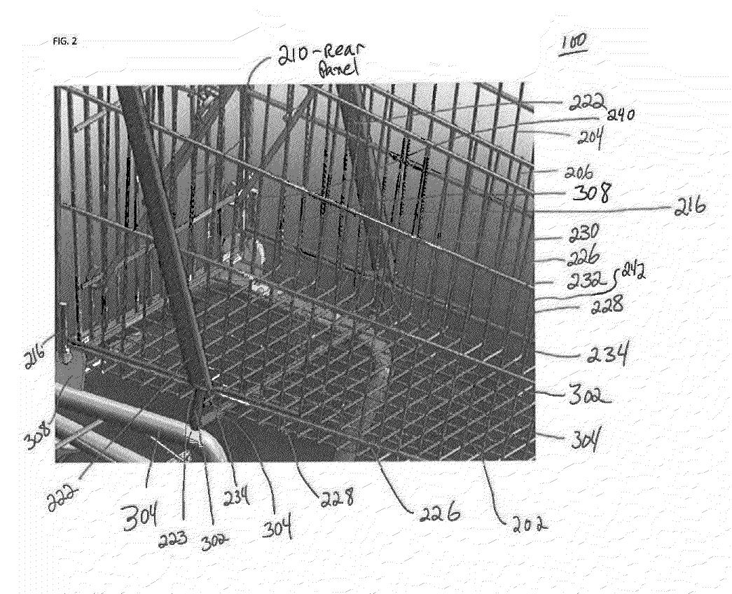

FIG. 2 is a perspective view of the shopping cart assembly 100 but showing an isolated portion of the inclined handle member 222. As stated above, the inclined handle member 222 is formed from an elongated tube 216 that also forms the handle 214 shown in FIG. 1. The bottom end 223 of the inclined handle portion or member 222 of the elongated tube 216 is fixedly attached to a horizontally-oriented spring wire 226 preferably by welding. The horizontal-oriented spring wire 226 is so named because the spring wire 226 extends away from the bottom end 223 of the inclined handle member 222 substantially horizontal to a surface on which the basket assembly is used and because the spring wire 226 acts as a spring, when it is attached to a basket rim wire 228, which is also considered to be horizontal or at least substantially horizontal.

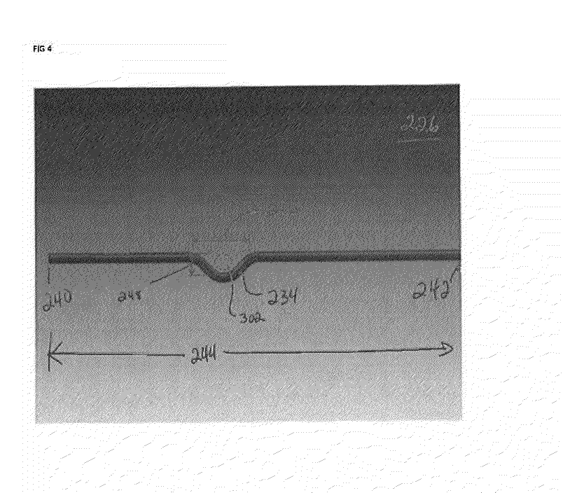

In a preferred embodiment, the horizontal spring wire 226 is solid with a circular or substantially-circular cross section, an overall length of between about six and twenty inches. Two opposing ends of the horizontal spring wire 226 are identified by reference numerals 240 and 242. (See FIG. 2 and FIG. 4.) In an alternate embodiment, the spring wire 226 can be hollow. It other embodiments, it can have cross-sectional shapes that are square, rectangular, triangular, oval or elliptical. For purposes of claim construction, the term, spring wire should be construed to include such other embodiments.

The spring wire 226 is attached to the rim wire 228 at or near locations that are near or proximate to the two ends 240, 242. The spring wire's attachment points are identified in FIG. 2 by reference numerals 230 and 232. They are preferably welds or “weldments” and are referred to herein after as the horizontal spring wire attachment points 230 and 232. In one embodiment (not shown), the attachment points 230 and 232 are co-located at the two ends 240 and 242 of the spring wire 226. The material from which the spring wire 226 is made, its cross sectional shape and the space or separation distance between the attachment points 230 and 232 determines the stiffness provided by the spring wire 226 relative to the rim wire 228 to which it is attached.

As described more fully below and in the applicant's co-pending patent application entitled “Basket-to-Frame Locking Clip,” which was filed 29 Mar. 2012, and having Ser. No. 13/433,928, and which is incorporated herein by reference in its entirety, the basket portion 200 and the frame portion 300 are “snapped” together using clips. The rear clips 308 enable the basket portion 200 to be attached to the frame portion 300 without tools. Increasing the stiffness of a rim wire that is “clipped” to a front-located basket-to-frame locking clip through a connector will increase the strength and ruggedness of the basket after the basket portion and frame portions are snapped together.

When the horizontal spring wire 226 is attached to a rim wire 228, it and the portion of the rim wire 228 that it is connected to, act together as a spring-like clip or two-wire “trap” for a basket-to-frame locking clip, such as the wire spade 302 shown in the figures or the clip disclosed in the aforementioned co-pending '928 application. The horizontal spring wire 226 also imbues an associated rim wire 228, i.e., a rim wire 228 to which the spring wire 226 is attached, a significantly increased stiffness along the length of the rim wire 228 to which the spring wire 226 is attached. The spring wire 226 in combination with the rim wire 228 thus provides both a spring-like clip and localized increased stiffness to the rim wire 228, i.e., an increased stiffness localized to where the spring wire 226 is attached, increasing or improving an assembled basket 100 ruggedness. The spring wire 226 obviates the need to manufacture the basket portion 200 with a horizontal rim wire 228 that would otherwise need to be much larger in diameter. The spring wire 226 thus enables the basket portion 200 to be lighter and less costly to manufacture.

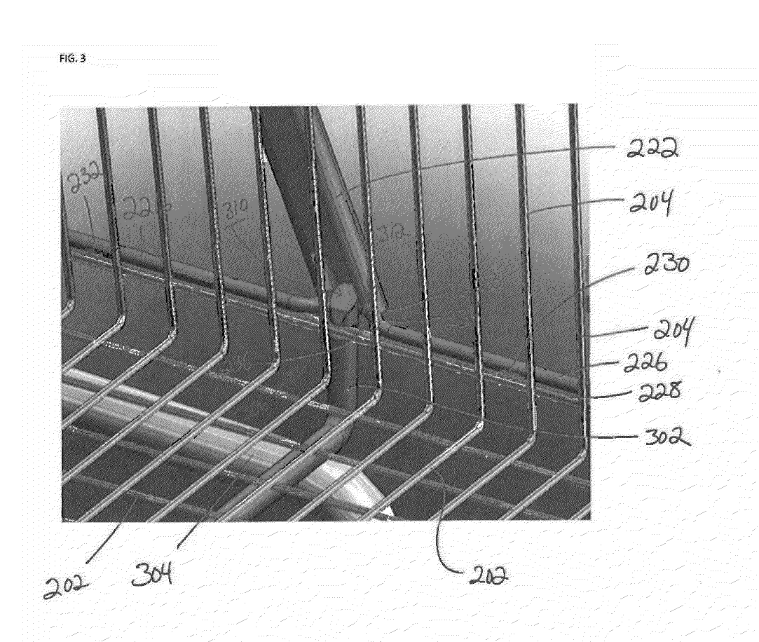

FIG. 3 is a more isolated view of the spring wire 226 showing its attachment to the rim wire 228 by a first weldment or weld joint 230 located near the first end 240 of the spring wire 226 and just in front of the back or rear end 210 of the basket portion 200. A second attachment or weldment is located near the opposite, second end 242 of the spring wire 226. The spaced-apart attachment points of the spring wire 226 to the rim wire 228 thus leaves an “intermediate” portion of the spring wire 226, i.e., the spring wire portion between the joints 230 and 232, unconnected or “free” to move laterally or “sideways” relative to the rim wire 228 that is also between the two weldments 230 and 232. The portion of the spring wire 226 and the portion of the rim wire 228 between the two joints 230, 232 are both able to deflect, relative to each other. The assembly also comprises a wire basket attachment spade 302 having a chamfered top end 310 and a slot 312 (See FIGS. 4, 7 and 8.) into which the rim wire 228 can be held. The two wires 226, 228 thus form a trap for the spade 302

FIG. 4 is a top view of the spring wire 226 shown lying in a horizontal plane and showing how the spring wire 226 is oriented when it is attached to a rim wire 228. The spring wire 226 has a first end 240 and an opposing second end 242. The space between them defines the length 244 of the spring wire, which is preferably about 12-14 inches but can be as short as 6-8 inches or as long as the side 204, 206 of the wire basket portion 200.

A U-shaped “detent” portion 234 is formed approximately midway between the two ends 240 and 242. In a preferred embodiment, the U-shaped detent 234 has a width 246 and a depth 248 selected such that when the spring wire 226 is attached to a rim wire, the assembly of the spring wire 226 to a straight rim wire 228 forms a hole 236 (as shown in FIG. 4) into which the spade 302 can be forcibly fit, causing the two wires to deflect outwardly from each other. Stated another way, in a preferred embodiment, the spade 302 has an outside diameter too big to freely slide into and through the “hole” 236 formed by the U-shaped detent 234 and a rim wire to which the spring wire 226 would be attached. Forcibly driving the combination spring wire 226 and rim wire 228 downwardly over the upright-oriented spade 302, as will happen when the basket portion 200 is attached to two, rear-located clips 308 (as shown in FIG. 2) and rotated toward the spade 302, will cause the two wires 226 and 228 to deflect outwardly from each other. Their elasticity will cause them to “trap” or engage the spade 302 and force the rim wire 228 of the basket portion 200 into the slot 312 as shown in FIG. 3.

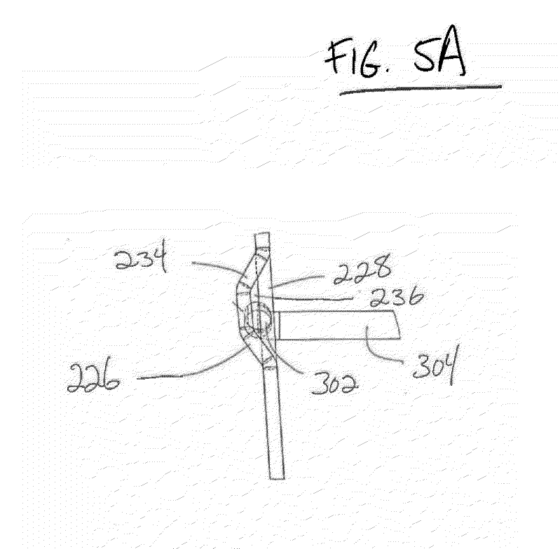

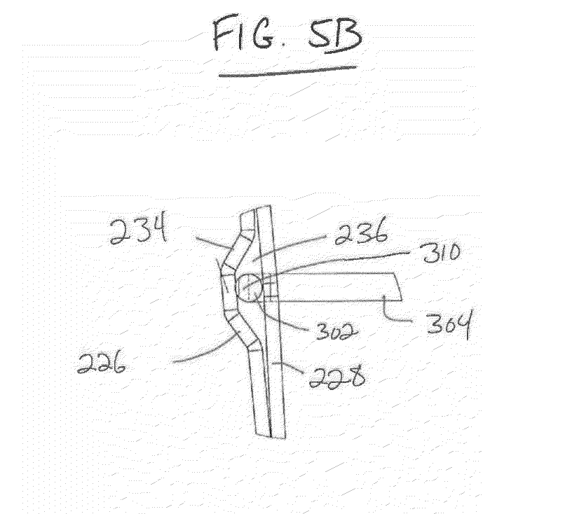

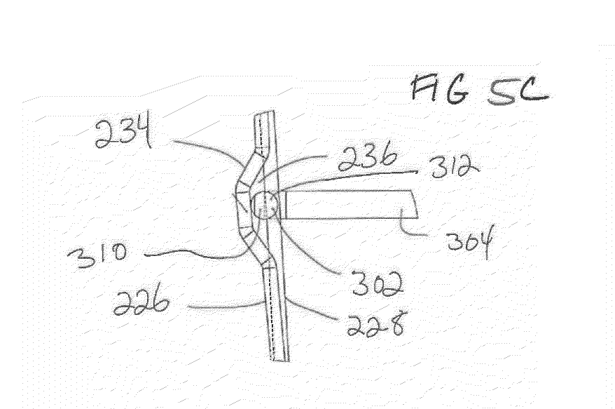

FIG. 5A and FIGS. 5B and 5C are top views of a spring wire 226 having a rim wire 228 attached below the spring wire 226. The U-shaped detent 234 projects outwardly and away from the rim wire 228 to define a hole 236. A portion of the top of the spade 302 can be seen in FIG. 5A as being located beneath the two wires 226, 228. Stated another way, in FIG. 5A, the two joined-together wires 226 and 228 are at rest atop the spade 302.

FIG. 5B shows the two wires being deflected away from each other as the two wires 226, 228 are driven over the chamfered top 310 of the spade 302, which happens when the basket portion 200 of the basket assembly 100 is being attached to the frame portion 300 using the process described in the aforementioned co-pending patent applications. The chamfered top 310 and the spade 302 thus act to provide a wire-separating force that is applied to both wires, which separates the wires 226 and 228 from each other as the chamfer 310 and wires 226, 228 are driven past each other. Wedge-shaped openings can be seen between the two wires 226 and 228 due to the outward deflection of the two wires 226, 228.

FIG. 5C shows the two wires 226, 228 after the rim wire 228 snaps into and is captured by a notch 312 formed into the spade 302. The two wires 226, 228 are considered to have trapped the rim wire 228 into the notch 312 in the spade 302, or vice versa.

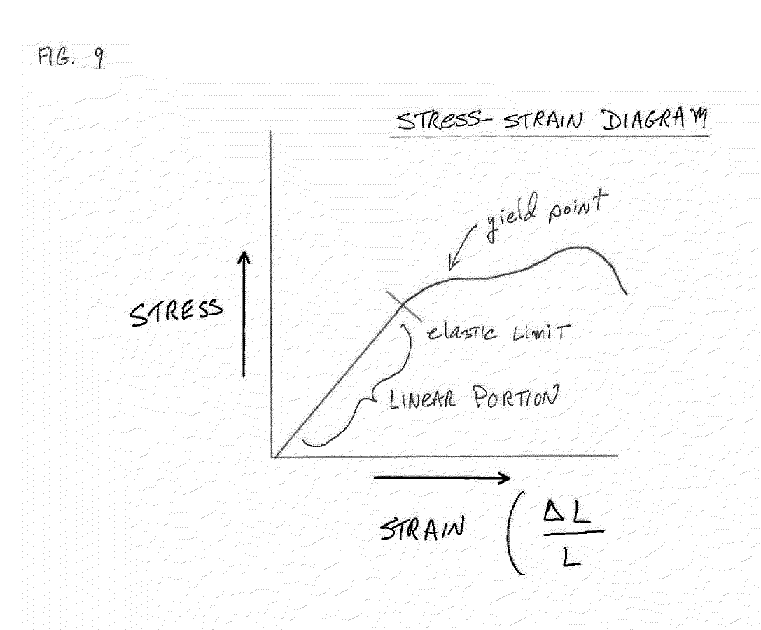

The spring wire 226 is preferably attached to the rim wire 228 by welding because welding is relatively fast, durable and inexpensive. The spring wire 226 can be made of a spring steel, however, spring steel tends to anneal when subjected to high temperatures, especially those common to welding. A low carbon steel is therefore preferred because of its lower cost as compared to spring steels and because it is generally easier to weld than spring steels. The physical characteristics of the spring wire 226 are chosen so that the spring wire 226 deflection relative to the rim wire 228 during assembly of the basket portion 200 to the frame portion 300 is well within the linear portion of both of the wires' stress-strain curves. See FIG. 9.

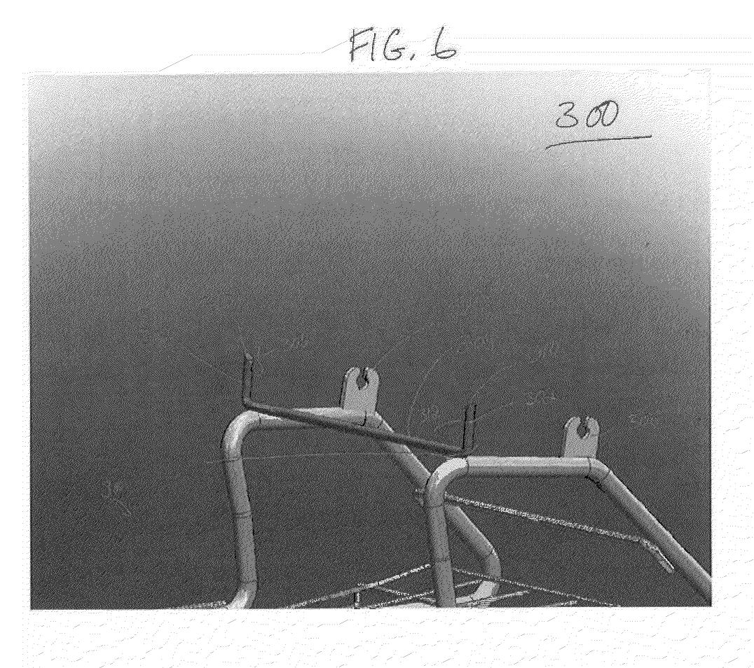

FIG. 6 is a depiction of the frame portion 300 but also showing the spade connectors 302 formed on the opposing ends of a relatively stiff heavy gauge generally U-shaped wire connecting rod 304. The spade portion 302 is provided with a basket-to-frame locking clip 306 as described in the applicant's co-pending application Ser. No. 13/433,928 entitled “Basket-to-Frame Locking Clip” filed March 29, 2012, the entire content of which is incorporated herein by reference. A rear basket-to-frame locking clip 308 described in the applicant's co-pending patent application Ser. No. ______, incorporated herein by reference, is also shown.

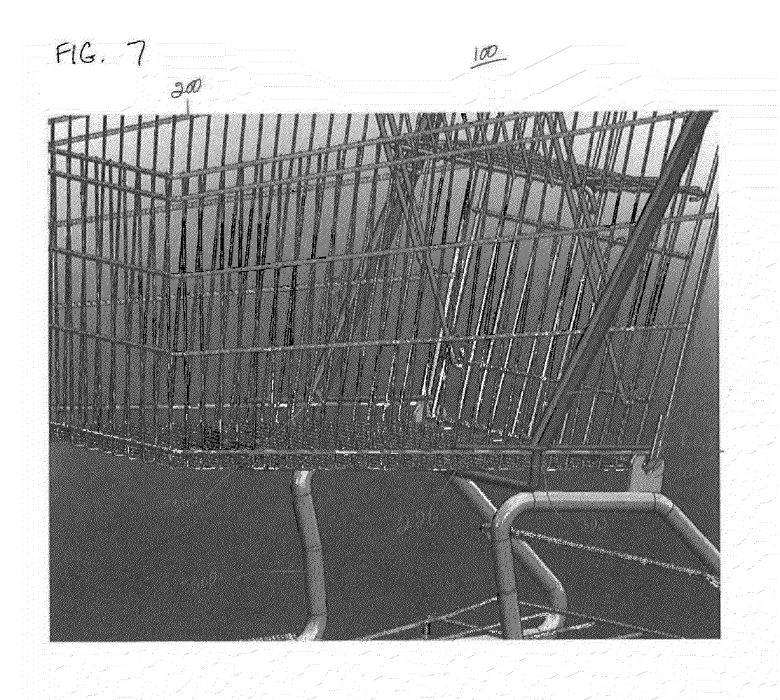

Referring now to FIG. 7, a basket portion 200 is attached to a frame portion 300 using the aforementioned wire clips 306 and 308. When the basket portion is to be attached to the frame portion, two rear-located rim wires 602 and 604 are placed into the rear basket-to-frame locking clip 308 as described in the aforementioned patent application Ser. No. ______. The rim wires 602 and 604 can be rotated as described in the application Ser. No. ______ until the downwardly and inclined handle portion 222 attached to the spring wire 226 meets the upright-standing spade portion 302. A downward force on the basket portion drives the rim wire 228 over an inclined chamfer 310 on the upright spade portion 302 until the rim wire 228 and spring wire 226 separate from each other to allow the spade 302 to slide between them. The rim wire 228 and spring wire 226 are forced downwardly over and past the chamfer 310 of the spade 302 until the rim wire 228 latches into the notch 312 effectively locking the rim wire 228 into the spade 302 by virtue of the additional stiffness provided by the spring wire 226 and the clamping force provided to the spade 302 by the wires' rigidities. As shown in FIG. 4, the detent 234 receives the spade portion 302 at the same time the spring wire 226 maintains the rim wire 228 in a relatively straight and latched condition inside the spade 302.

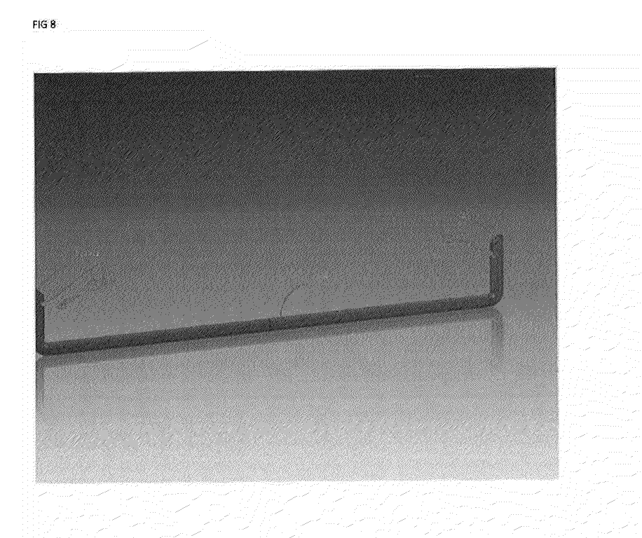

FIG. 8 shows details of the wire basket attachment spade 302. The long, straight portion is the wire connecting rod 304. The slots 312 on the sides of both spades 302 are located below the chamfers 310. The chamfers 310 allow or facilitate the spade's insertion into the holes 236 between the spring wires 226 and the rim wires 228. The slots 312 formed in the spades 302, which are attached to the frame portion 300, lock the basket portion 200 to the frame portion 300.

The foregoing description is purposes of illustration only. The true scope of the invention is set forth in the appurtenant claims.

What is claimed is:

1. A mechanism for attaching a wire basket to a frame, the mechanism comprising:
a substantially linear spring, configured to be attached to a substantially linear portion of a wire basket rim wire, the linear spring being additionally configured to be substantially parallel to the basket rim wire and configured to be attached to the basket rim wire at first and second attachment points, which are spaced apart from each other such that the basket rim wire and the substantially linear spring are able to deflect away from each other responsive to lateral wire-separating force applied to the basket rim wire and the linear spring.

2. The mechanism of claim 1, wherein the substantially linear spring is comprised of length of wire formed to have a detent, the detent having a shape reminiscent of the Arabic letter U, the detent being located between the first and second attachment points.

3. The mechanism of claim 1, further comprised of a substantially linear portion of a wire basket rim wire that forms part of a wire basket;

4. The mechanism of claim 3, further comprising a basket attachment spade, configured to attach a basket frame portion to the wire basket rim wire.

5. The mechanism of claim 4, wherein the basket attachment spade is comprised of a chamfered top and a notch formed into a side of the basket attachment spade, the basket attachment spade being configured to fit within the detent and to receive the basket rim wire into the notch.

6. A method of attaching a wire basket to a frame, the frame having a substantially upright basket attachment spade with a chamfered top and side-located notch, the wire basket having a substantially linear portion of a rim wire and a substantially linear spring attached to the substantially linear portion of rim wire, the linear spring being substantially parallel to the basket rim wire and attached to the basket rim wire at first and second attachment points, the linear spring having a detent, the detent having a shape reminiscent of the Arabic letter U, the detent being located between first and second attachment points, the method comprising the steps of:
moving the basket rim wire over the chamfered top of the basket attachment spade and into the side-located notch of the basket attachment spade.

7. A shopping cart comprising:
a frame portion, the frame portion being comprised of a wire basket attachment spade; and
a wire mesh basket portion, the basket portion being comprised of a spring wire and a rim wire, which comprise a wire trap, the wire trap being configured to receive the attachment spade and to lock the basket portion to the wire basket attachment spade.

8. The shopping cart of claim 7, wherein the wire basket attachment spade is comprised of a chamfered top and a slot formed into the spade below the chamfered top.

9. The shopping cart of claim 7, wherein the spring wire has a predetermined length between first and second ends, the spring wire being attached to the rim wire at localized connections proximate to the first and second ends such that the rim wire and spring wire between the first and second ends are able to deflect relative to each other.
